(19) United States
(12) Patent Application Publication
(10) Pub. No.: US 2026/0080696 A1
(43) Pub. Date: Mar. 19, 2026

(54) METHOD AND SYSTEM FOR ANALYZING PATHOLOGICAL IMAGES BASED ON MAGNIFICATION-ALIGNED TRANSFORMER (MAT)

(71) Applicant: GUANGDONG PROVINCIAL PEOPLE'S HOSPITAL, Guangzhou (CN)

(72) Inventors: Zaiyi LIU, Guangzhou (CN); Chu HAN, Guangzhou (CN); Bingchao ZHAO, Guangzhou (CN); Jiatai LIN, Guangzhou (CN); Zhenwei SHI, Guangzhou (CN); Yanqi HUANG, Guangzhou (CN)

(21) Appl. No.: 19/399,778

(22) Filed: Nov. 25, 2025

Related U.S. Application Data
(63) Continuation of application No. PCT/CN2023/129780, filed on Nov. 3, 2023.

(30) Foreign Application Priority Data
Sep. 27, 2023 (CN) 202311259696.5

(51) Int. Cl. G06V 20/69; G06T 7/00; G06V 10/26; G06V 10/44; G06V 10/764; G06V 10/82

(52) U.S. Cl. CPC G06V 20/698; G06T 7/0012; G06V 10/267; G06V 10/454; G06V 10/764; G06V 10/82; G06T 2207/30024

(57) ABSTRACT

A method for analyzing pathological images based on a magnification-aligned transformer (MAT) is provided, in which a pathological image dataset is identified and segmented to obtain pathological image patches; the pathological image patches is screened to obtain a patch set; an MAT classification network model including a self-supervised magnification alignment module and a global-local Transformer classification module is constructed; the MAT classification network model is trained for self-supervised magnification alignment using the patch set in the self-supervised magnification alignment module; the MAT classification network model is further trained using a convolutional neural network (CNN)-transformer; and a pathological image classification prediction result is obtained using the trained MAT classification network model. A system for implementing such method is also provided.

### CROSS-REFERENCE TO RELATED APPLICATIONS

This application is a continuation of International Patent Application No. PCT/CN2023/129780, filed on Nov. 3, 2023, which claims the benefit of priority from Chinese Patent Application No. 202311259696.5, filed on Sep. 27, 2023. The content of the aforementioned application, including any intervening amendments thereto, is incorporated herein by reference in its entirety.

### TECHNICAL FIELD

This application relates to image analysis, and more particularly to a method and system for analyzing pathological images based on a magnification-aligned transformer (MAT).

### BACKGROUND

Histopathological tissue sections can be converted by a digital slide scanner into whole-slide images (WSIs). With the advancement of image processing technologies, it has become possible to achieve the algorithm-aided intelligent pathological diagnosis, giving rise to the field of computational pathology. In recent years, with the rapid development of artificial intelligence, deep learning has achieved remarkable success in many computational pathology tasks, such as cancer diagnosis, prognosis, and risk stratification. Although the deep learning models have demonstrated excellent performance in these prediction tasks, they still suffer from limitations in the image processing speed and efficiency. For example, the existing methods generally require 5-10 min to process and analyze a single WSI, making it difficult to meet the requirements of clinical diagnosis.

The primary factor affecting computational efficiency is the gigapixel-level resolution of WSIs. To capture sufficient image information, the existing methods typically process WSIs at a high magnification level (e.g., 400× or 200×). Although the images are compressed to a certain extent, it still requires substantial consumption of computation resources and time. Although using lower-resolution images (e.g., 100× or 50×) can significantly reduce the consumption of computation time and resources, it leads to severe loss of image information, considerably reducing the model accuracy. Therefore, the balance between model performance and efficiency is essentially a trade-off between model performance and image resolution.

To fully utilize low-magnification images, the following two issues must be addressed: (1) whether the low-magnification images possess diagnostic value; and (2) whether deep learning can recover predictive information from such low-magnification images. Clinically, pathologists are able to make preliminary assessments even at relatively low magnifications, which indicates that the low-magnification images do have certain diagnostic values. Technically, extensive studies have demonstrated that deep learning-based super-resolution algorithms can generate high-magnification images from low-magnification inputs, thereby demonstrating that the deep learning can restore image information from low-magnification inputs.

However, although using low-magnification images can remarkably reduce the consumption of time and computation resources, the substantial loss of detailed information will lead to severe model performance degradation. Regarding the existing methods that analyze pathological images at high magnifications (e.g., 400× or 200×), considerable consumption of time and computation resources is required, making it difficult to meet the practical application requirements. Therefore, there is an urgent need to effectively integrate the advantages of both high-magnification and low-magnification images to enable the rapid pathological image analysis.

### SUMMARY

An object of the disclosure is to provide a method and system for analyzing pathological images based on a magnification-aligned Transformer (MAT) to overcome the defects and deficiencies in the prior art. In particular, the present disclosure provides an MAT classification network model that employs a self-supervised magnification alignment mechanism to align low-magnification images with high-magnification images at the feature level. Moreover, it utilizes a convolutional neural network (CNN)-Transformer attention mechanism to predict pathological image features. This method makes full use of the information contained in the low-magnification images and significantly reduces the time and space costs required for model prediction.

Technical solutions of the present disclosure are described as follows.

In a first aspect, this application provides a method for analyzing pathological images based on a magnification-aligned Transformer (MAT), comprising: acquiring a pathological image dataset composed of a plurality of whole-slide images (WSIs);
identifying and segmenting a tissue region within each of the plurality of WSIs to obtain a mask corresponding to the tissue region;
removing masks with a tissue area lower than a preset threshold;
performing a patching operation on the tissue region based on the rest of the masks;
constructing a MAT classification network model;
wherein the MAT classification network model comprises a self-supervised magnification alignment module and a global-local Transformer classification module;
the self-supervised magnification alignment module comprises two magnification-dependent feature extractors, wherein the two magnification-dependent feature extractors are structurally identical, and are respectively configured to extract features with fine-grained information and generate semantically aligned features with high similarity;
the global-local Transformer classification module comprises a global attention submodule and a local attention submodule; the global attention submodule is configured to explore global features among instances based on Transformer's capability to learn global information; and the local attention submodule is configured to explore local features among the instances based on convolutional neural network (CNN)'s capability to learn detail information;
training the MAT classification network model through steps of.
performing self-supervised magnification alignment training on the MAT classification network model to align low-magnification images to high-magnification images at a feature level to obtain a magnification-aligned feature representation;
exploring, by a transformer in the global attention submodule, global information of the magnification-aligned feature representation;
capturing, by a CNN in the local attention submodule, local information of the magnification-aligned feature representation;
aggregating pathological image features based on the global information and the local information to obtain aggregated features;
inferring, by the fully connected layer, the prediction based on the aggregated features;
computing a prediction loss; and
obtaining a trained MAT classification network model through a backpropagation algorithm;
wherein a self-attention mechanism in the transformer of the global attention submodule covers all patches in the magnification-aligned feature representation to obtain global attention; and the CNN in the local attention submodule, based on a fixed-size convolutional kernel and a sliding window mechanism, is more sensitive to adjacent patches in the magnification-aligned feature representation; and
obtaining a pathological image classification prediction result using the trained MAT classification network model.

In some embodiments, the step of identifying and segmenting the tissue region within each of the plurality of WSIs to obtain the mask, and performing the patching operation on the tissue region based on the mask comprises:
performing binary classification on the pathological image dataset by using ImageNet to distinguish the tissue region from blank and contaminated regions, so as to obtain the mask corresponding to the tissue region; and
performing the patching operation on the tissue region based on the mask, wherein all WSIs are cropped into patches of a predetermined size; and
inputting the patches of the predetermined size into a ResNet50 pre-trained on ImageNet or a pathology foundation model for feature extraction;
wherein a size of the patches is scaled proportionally with a magnification of a corresponding WSI.

In some embodiments, the step of performing self-supervised magnification alignment training on the MAT classification network model comprises:
based on the two magnification-dependent feature extractors Φ_{High}(·) and Φ_{Align}(·) freezing parameters of the Φ_{High}(·) to extract the high-magnification features and generate the semantically aligned features;
wherein the Φ_{High}(·) is configured to receive a high-magnification image as input and output the high-magnification features; and
inputting a low-resolution image having an identical field of view as the high-magnification image into the Φ_{Align}(·) to generate the semantically aligned features; and
processing the high-magnification features and the semantically aligned features by using an L1 loss function to reduce an absolute distance between features of different magnifications, so as to achieve semantic alignment,
wherein the L1 loss function is expressed as:

$${L}_{MA} = {\sum }_{i = 1}^{n} \vert {X}_{i} - {x}_{i} \vert ;$$

wherein Xᵢ is an output feature of an i-th patch from the Φ_{High}(·), and xᵢ is an output feature of an i-th patch from the Φ_{Align}(·).

In some embodiments, the step of exploring, by the transformer in the global attention submodule, the global information of the magnification-aligned feature representation comprises:
inputting a feature F^{B×(N+1)×L} of the patches into the global attention submodule;
exploring the global information Out^{B×(N+1)×L} of the magnification-aligned feature representation using the transformer in the global attention submodule through steps of:
   generating a query (Q) vector a key (K) vector and a value (V) vector using the fully connected layer;
   generating a global attention matrix based on the self-attention mechanism using the Q vector and the K vector;
   calculating a dot product of the global attention matrix and the V vector; and
   concatenating the dot product with a randomly initialized class token to generate an output Out^{B×(N+1)×L} as the global information, expressed as;

$$\begin{matrix}Q = MLP ( {F}^{B \times N \times L} ) ; \\ K = MLP ( {F}^{B \times N \times L} ) ; \\ V = MLP ( {F}^{B \times N \times L} ) ; \\ {Att}^{B \times N \times L} = Softmax ( {Transpose}_{0 , 2 , 1} ( Q \times K ) ) ; \\ {Att}^{B \times N \times L} = Concat ( V \times {Transpose}_{0 , 2 , 1} ( {Att}^{B \times N \times L} ) ) ; and \\ {Out}^{B \times ( N + 1 ) \times L} = Concatenate ( {Att}^{B \times N \times L} , {f}_{Class}^{1 \times L} ) ;\end{matrix}$$

wherein B represents a batch size; N represents the number of features; L represents a feature length; l represents a classification token feature; MLP represents a multi-layer perceptron; Q, K and V represent intermediate variables involved in conversion of the feature F^{B×N×L}; Att^{B×N×L} represents an intermediate variable of the self-attention mechanism;

$${f}_{Class}^{1 \times L}$$

is a class token, which is generated through a random initialization strategy and used to learn global instance information; and Transpose_{0,2,1}(·) represents an operation that transposes dimensions of a tensor from (0, 1, 2) to (0, 2, 1).

In some embodiments, the step of capturing, by the CNN in the local attention submodule, the local information of the magnification-aligned feature representation comprises:
constructing an instance-level feature pyramid by using dilated convolutions in the CNN respectively with dilation rates of 1, 3 and 5 to capture instance information at three scales, respectively denoted as f₁, f₂ and f₃; and
fusing the instance information at the three scales by averaging to acquire the local information of the magnification-aligned feature representation, expressed as:

$$\begin{matrix}{f}_{1} = {Conv}_{1} ( f ) ; \\ {f}_{2} = {Conv}_{3} ( f ) ; \\ {f}_{3} = {Conv}_{5} ( f ) ; and \\ {f}_{out} = Mean ( {f}_{1} , {f}_{2} , {f}_{3} ) ;\end{matrix}$$

wherein f represents an input feature, Convᵢ(·) represents a dilated convolution with a dilation rate of i, Mean(·) represents an averaging pooling operation, and fₒᵤₜ represents an output feature.

In some embodiments, the step of inferring, by the fully connected layer, the prediction result based on the aggregated features, and computing the prediction loss comprises:
during a training process, computing a loss of the aggregated features through the fully connected layer using a cross-entropy loss function to generate augmented data, expressed as:

$${L}_{GLT} = - {\sum }_{i = i}^{n} {y}_{i} log ;$$

wherein [symbol] represents an output corresponding to an i-th WSI among the plurality of WSIs, and yᵢ represents a label corresponding to the i-th WSI;
arranging the augmented data in the same order as that before aggregation of the pathological image features; and
inferring the prediction result using the fully connected layer of the MAT classification network model.

In some embodiments, the step of training the MAT classification network model further comprises:
before training, subjecting the magnification-aligned feature representation to data augmentation and class label embedding through steps of:
performing random sampling-based population on features of the magnification-aligned feature representation; and
concatenating populated features with a randomly initialized class token to serve as an input of a transformer layer, so as to maintain normality of a feature matrix.

In some embodiments, the pathological image features are aggregated based on the global information and the local information using an averaging operation.

In a second aspect, this application provides a system for implementing the rapid analysis method described above, comprising:
a feature engineering module;
a model construction module;
an alignment and attention training module; and
an image testing module;
wherein the feature engineering module is configured to perform:
   acquiring the pathological image dataset composed of the plurality of WSIs;
   identifying and segmenting the tissue region within each of the plurality of WSIs to obtain the mask corresponding to the tissue region;
   removing masks with the tissue area lower than the preset threshold;
   performing the patching operation on the tissue regions based on the rest of the masks;
the model construction module is configured to construct the MAT classification network model;
wherein the MAT classification network model comprises the self-supervised magnification alignment module and the global-local Transformer classification module;
the self-supervised magnification alignment module comprises two magnification-dependent feature extractors, wherein the two magnification-dependent feature extractors are structurally identical, and are respectively configured to extract features with fine-grained information and generate semantically aligned features with high similarity;
the global-local Transformer classification module comprises the global attention submodule and the local attention submodule; the global attention submodule is configured to explore global features among instances based on Transformer's capability to learn global information; and the local attention submodule is configured to explore local features among the instances based on CNN's capability to learn detail information; and
the alignment and attention training module is configured to perform:
training the MAT classification network model through steps of
performing self-supervised magnification alignment training on the MAT classification network model to align low-magnification images to high-magnification images at the feature level to obtain the magnification-aligned feature representation;
exploring, by the transformer in the global attention submodule, the global information of the magnification-aligned feature representation;
capturing, by the CNN in the local attention submodule, the local information of the magnification-aligned feature representation;
aggregating pathological image features based on the global information and the local information to obtain the aggregated features;
inferring, by the fully connected layer, the prediction result based on the aggregated features;
computing the prediction loss; and
obtaining the trained MAT classification network model through the backpropagation algorithm;
wherein the self-attention mechanism in the transformer of the global attention submodule covers all patches in the magnification-aligned feature representation to obtain global attention; and the CNN in the local attention submodule, based on the fixed-size convolutional kernel and the sliding window mechanism, is more sensitive to adjacent patches in the magnification-aligned feature representation; and
the image testing module is configured to obtain the pathological image classification prediction result using the trained MAT classification network model.

In a third aspect, this application provides an electronic device, comprising:
at least one processor; and
a memory communicatively coupled to the at least one processor;
wherein the memory is configured for storing computer program instructions executable by the at least one processor; and the at least one processor is configured for executing the computer program instructions to implement the rapid analysis method described above.

Compared to the prior art, the present disclosure has the following beneficial effects.

(1) The present disclosure adopts a self-supervised magnification alignment mechanism to align low-magnification images with high-magnification images at the feature level, thereby restoring the lost information of the low-magnification images and compensating for the information loss caused by magnification reduction.

(2) Furthermore, the present disclosure employs a CNN-Transformer attention mechanism, in which a Transformer in a global attention submodule is used to capture global information of a magnification-aligned feature representation, and the CNN in a local attention submodule is used to extract local information of the magnification-aligned feature representation. The pathological image features are aggregated based on the global information and the local information, and then used for prediction, significantly reducing the computational and memory costs required for model prediction.

### BRIEF DESCRIPTION OF THE DRAWINGS

In order to illustrate the technical solutions in the present disclosure more clearly, the accompanying drawings needed in the description of the embodiments will be briefly described below. It is evident that presented in the accompanying drawings described below are only some embodiments of the present disclosure. For those of ordinary skill in the art, other accompanying drawings can be obtained based on these accompanying drawings without making creative effort.

FIG. 1 is a flowchart of a method for analyzing pathological images based on a magnification-aligned Transformer (MAT) according to an embodiment of the present disclosure;

FIG. 2 is a flowchart of tissue segmentation of a pathological image according to an embodiment of the present disclosure;

FIGS. 3A-3B are structural diagrams of an MAT model according to an embodiment of the present disclosure;

FIG. 4 schematically shows a magnification alignment module according to an embodiment of the present disclosure;

FIG. 5 schematically shows data augmentation, a local attention submodule and a global attention submodule according to an embodiment of the present disclosure;

FIG. 6 is a schematic diagram of a system for analyzing pathological images based on the MAT according to an embodiment of the present disclosure; and

FIG. 7 is a structural diagram of an electronic device according to an embodiment of the present disclosure.

### DETAILED DESCRIPTION OF EMBODIMENTS

In order to make the objects, technical solutions and advantages of the present disclosure clearer, the present disclosure will be described clearly and completely below in conjunction with the accompanying drawings and embodiments. Obviously, described herein are merely some embodiments of the present disclosure, rather than all embodiments. Based on the embodiments in the present disclosure, all other embodiments obtained by those of ordinary skill in the art without making creative effort shall fall within the scope of the present disclosure defined by the appended claims.

As used herein, the term “embodiment” means that a particular feature, structure or characteristic described in connection with an embodiment may be included in at least one embodiment of the present disclosure. The appearance of this term at various locations in the specification does not necessarily refer to the same embodiment, nor does it imply mutually exclusive or alternative embodiments. It will be understood by those skilled in the art, both explicitly and implicitly, that the embodiments described herein may be combined with other embodiments.

Transformer is a neural network model based on an attention mechanism, which was originally proposed by Vaswani et al. in 2017. It achieved significant breakthroughs in natural language processing (NLP) tasks and has been widely applied in machine translation, text generation and language understanding. By introducing a self-attention mechanism and several other key techniques, the Transformer model effectively overcomes the limitations of traditional neural networks in handling long-sequence data, and has become an essential model in the field of natural language processing.

Scaling alignment refers to aligning pathological images of different magnifications in the feature space to restore the information loss caused by a decrease in image resolution.

A magnification-aligned Transformer (MAT) designed in the present disclosure is an integrated, fully automatic and time-efficient whole slide image (WSI) classification method. The MAT is a two-stage hybrid WSI classification model based on a convolutional neural network (CNN) and a transformer architecture. The MAT includes a self-supervised magnification-aligned (SSMA) module and a global-local transformer (GLT), which are respectively configured to perform a feature alignment task from low to high magnification and a WSI classification task.

Inheriting the concept of multiple instance learning, the MAT classification approach treats a WSI as a bag, in which each patch is regarded as an instance within the bag. A bag is defined as positive if it contains at least one positive instance; otherwise, it is defined as negative. The input WSI is first cropped into non-overlapping patches, followed by a feature extraction operation that aims to compress pixel-level information into high-level semantic representations. When the WSI is of low magnification and the goal is to achieve prediction performance close to that of high-magnification images, a magnification alignment model is employed to extract features; otherwise, a model pre-trained on ImageNet is used. Subsequently, the extracted high-level semantic features are input into the WSI classification model (GLT) to perform prediction on the WSI.

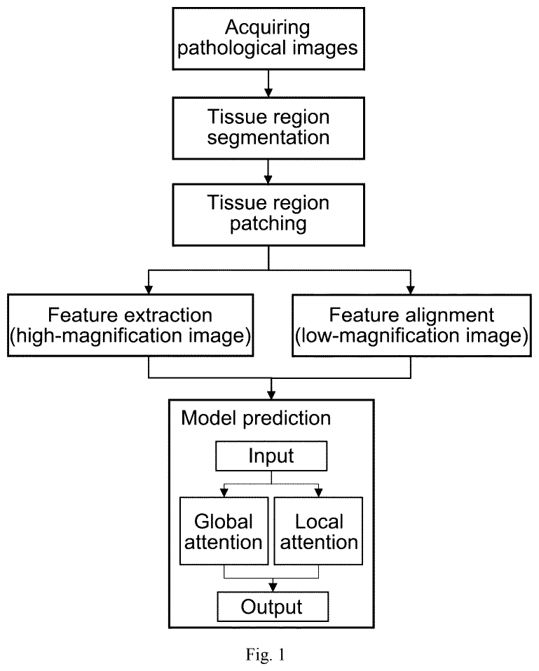

As shown in FIG. 1, an embodiment of the present disclosure provides a method for analyzing pathological images based on a magnification-aligned Transformer (MAT), including the following steps.

(S1) A pathological image dataset composed of a plurality of whole-slide images (WSIs) is acquired. A tissue region within each of the plurality of WSIs is identified and segmented to acquire a mask corresponding to the tissue region. Masks with a tissue area lower than a preset threshold are removed. A patching operation is performed on the tissue region based on the rest of the masks.

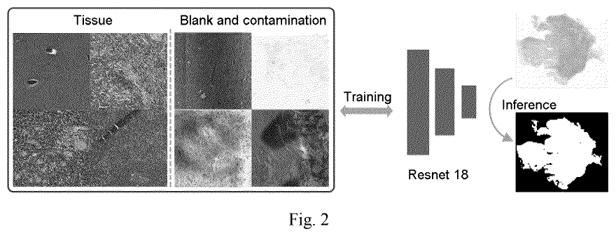

In some embodiments, as shown in FIG. 2, in step (1), the steps of identifying and segmenting the tissue region within each of the plurality of WSIs to obtain the mask, and performing the patching operation on the tissue region based on the mask includes the following steps.

(S11) Binary classification is performed on the pathological image dataset by using ImageNet to distinguish the tissue region from blank and contaminated regions, so as to obtain the mask corresponding to the tissue region.

In some embodiments, in step (S11), an Adam optimizer is employed. The Adam optimizer can adaptively adjust the learning rate based on the gradients of the parameters and the squares of historical gradients, thereby better accommodating different parameters and datasets. Of course, other types of optimizers are also applicable to the technical solutions of the present disclosure.

(S12) The patching operation is performed on the tissue region based on the mask, in which all WSIs are cropped into patches of a predetermined size. The patches of the predetermined size are input into a ResNet50 pre-trained on ImageNet or a pathology foundation model for feature extraction.

In some embodiments, a size of the patches is scaled proportionally with a magnification of a corresponding WSI. Specifically, the smaller the magnification of the image, the smaller the patch; conversely, the larger the magnification of the image, the larger the patch.

In some embodiments, in a low-magnification scenario: when the image magnification is 100×, the patch size is 112×112 pixels; when the image magnification is 50×, the patch size is 56×56 pixels.

For example, in a high-magnification scenario: when the image magnification is 200×, the patch size is 224×224 pixels.

WSIs typically contain many non-tissue regions, such as blank areas, artifacts introduced during slide preparation, and manual markings. Conventional thresholding methods and texture-based analysis approaches tend to misclassify WSIs that exhibit significant variations in color and morphology. To address this, the present disclosure designs a WSI tissue segmentation process. With reference to FIG. 2, WSI tissue segmentation is performed through the following steps.

First, a plurality of tissue-region images and non-tissue region images (e.g., blank and contaminated regions) are randomly selected from The Cancer Genome Atlas (TCGA) pathological image repository.

Next, all images are cropped into patches of 224×224 pixels and randomly shuffled to serve as inputs to a ResNet18 network.

Then, the ResNet18 network is pre-trained on ImageNet, and then used for binary classification of tissue and non-tissue regions. During training, the Adam optimizer is employed, and a binary cross-entropy loss function is used. The training data are divided into a training set and a validation set.

Finally, the trained ResNet18 model is applied to segment the tissue regions of all WSIs involved in the present disclosure.

(S2) A MAT classification network model is constructed. The MAT classification network model includes a self-supervised magnification alignment module and a global-local Transformer classification module. The self-supervised magnification alignment module is trained through self-supervised learning to align low-magnification images with high-magnification images at the feature level with minimal information loss. The global-local Transformer classification module includes a global attention submodule and a local attention submodule. The global attention submodule is configured to explore global features among instances based on Transformer's capability to learn global information, while the local attention submodule is configured to explore local features among the instances based on convolutional neural network (CNN)'s capability to learn detail information. The step (S2) includes the following steps.

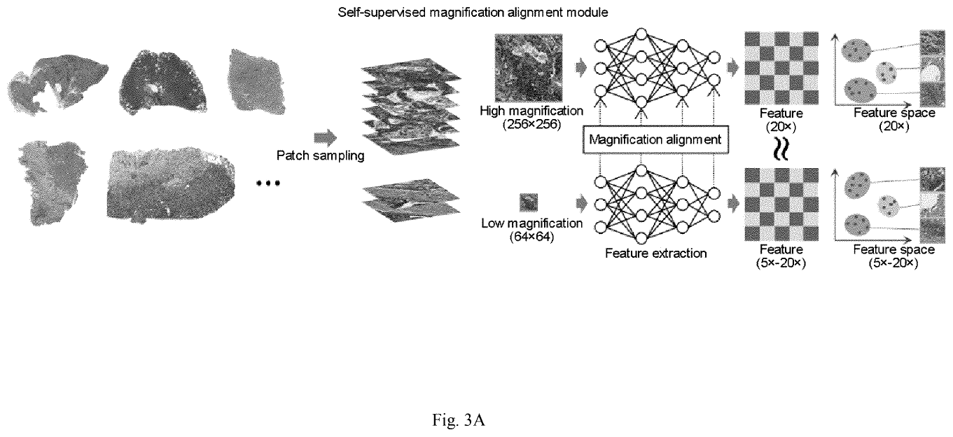

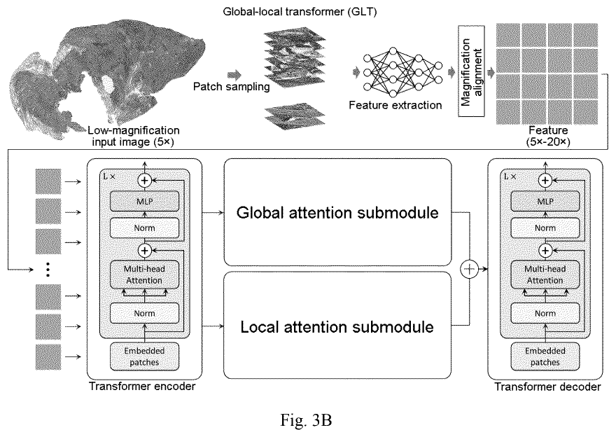

(S21) As shown in FIG. 3A, the self-supervised magnification alignment module includes two magnification-dependent feature extractors, Φ_{High}(·) and Φ_{Align}(·). The two magnification-dependent feature extractors are structurally identical. The Φ_{High}(·) is configured to extract features with fine-grained information, and the Φ_{Align}(·) is configured to generate semantically-aligned features with high similarity. In this embodiment, the two magnification-dependent feature extractors are implemented using the ResNet50 model pre-trained on ImageNet. It should be understood, however, that the feature extractors are not limited to ResNet50, and any network having a feature extraction capability may be employed as a feature extractor for images.

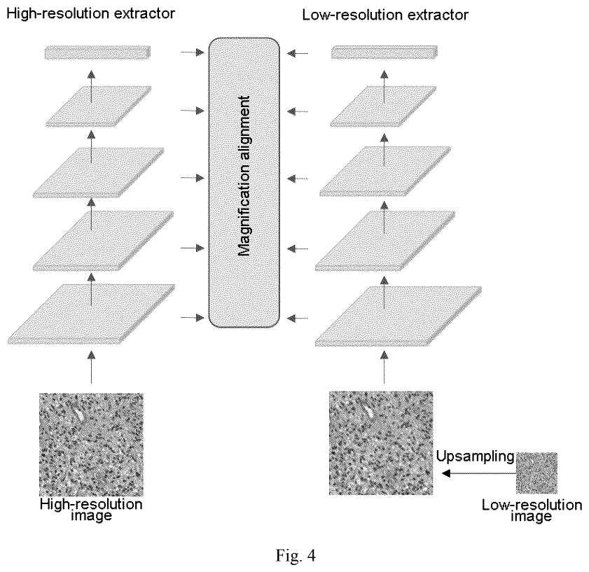

As shown in FIG. 4, the Φ_{High}(·) is regarded as a standard feature extractor, with its parameters frozen during the training process. Φ_{High}(·) is configured to receive a high-magnification image I_{High} as input and output a feature f_{High} serving as a reference for alignment. In contrast, Φ_{Align}(·) is configured to receive a low-resolution image I_{Low} having an identical field of view as I_{High} and output an aligned feature f_{Align}. The alignment operation is performed on each image patch to ensure that the model learns complete image information. However, only the feature vectors output by the feature extractors are utilized for subsequent WSI prediction tasks.

(S22) The global-local Transformer classification module (GLT model) is a convolutional neural network (CNN)-Transformer hybrid neural network designed based on multiple instance learning (MIL), in which an entire WSI is treated as a bag and patches are regarded as instances within the bag. MIL mitigates memory overload caused by the high resolution of WSIs, enabling the deep learning model to process an entire image at once. However, existing MIL models primarily focus on establishing relationships between instances and labels, while neglecting correlations among instances and between instances and the global image. To address this issue, the global-local Transformer classification module is configured to include the local attention submodule and the global attention submodule, which leverage the CNN's sensitivity to local information and the Transformer's capability of modeling global dependencies to explore correlations between patches as well as between patches and the WSI. By effectively integrating these correlations through Transformer layers, prediction accuracy is improved.

Referring again to FIG. 3A, the specific configurations of the local attention submodule and the global attention submodule are further described as follows.

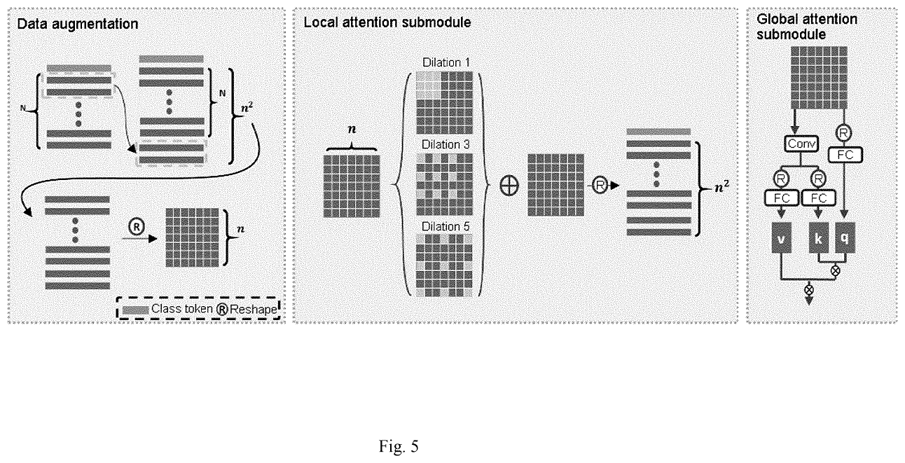

(S211) In the local attention submodule, capturing interactions among different tissue regions is critical for accurately predicting WSI-level tasks. To this end, the local attention submodule is configured to capture local information using convolutional operations in the CNN, and a local attention unit is designed in the local attention submodule. As illustrated in the local attention submodule of FIG. 5, convolutional kernels provide a fixed receptive field, which is sensitive to local information but limits interactions over a larger spatial context. Therefore, an instance feature pyramid is constructed by using dilated convolutions respectively with dilation rates of 1, 3 and 5 to capture instance information at multiple scales. The features at three scales are fused through an averaging operation. In this module, the class token does not participate in the computation of attention. This can be expressed as follows:

$$\begin{matrix}{f}_{1} = {Conv}_{1} ( f ) ; \\ {f}_{2} = {Conv}_{3} ( f ) ; \\ {f}_{3} = {Conv}_{5} ( f ) ; and \\ {f}_{out} = Mean ( {f}_{1} , {f}_{2} , {f}_{3} ) .\end{matrix}$$

In the above formulas, f represents an input feature, Convᵢ(·) represents a dilated convolution with a dilation rate of i, Mean(·) represents an averaging pooling operation, and fₒᵤₜ represents an output feature.

(S222) In the global attention submodule, conventional MIL models consider correlations between instances and labels but lack the capability to capture global dependencies, resulting in an incomplete consideration of the semantic features of a WSI. The present disclosure provides a patch-level global attention submodule to explore highly predictive features within a bag, as illustrated in the global attention submodule of FIG. 5.

A feature F^{B×(N+1)×L} of the patches is input into the global attention submodule. The global information Out^{B×(N+1)×L} of the magnification-aligned feature representation is explored using the transformer in the global attention submodule through the following steps. A query (Q) vector, a key (K) vector and a value (V) vector are generated by using the fully connected layer. A global attention matrix is generated based on the self-attention mechanism using the Q vector and K vector. A dot product of the global attention matrix and the V vector is calculated. The dot product is concatenated with a randomly initialized class token to obtain an output Out^{B×(N+1)×L} as the global information. As shown in FIG. 3B, a procedure of an algorithm for the global attention submodule is defined as follows:

$$\begin{matrix}Q = MLP ( {F}^{B \times N \times L} ) ; \\ K = MLP ( {F}^{B \times N \times L} ) ; \\ V = MLP ( {F}^{B \times N \times L} ) ; \\ {Att}^{B \times N \times L} = Softmax ( {Transpose}_{0 , 2 , 1} ( Q \times K ) ) ; \\ {Att}^{B \times N \times L} = Concat ( V \times {Transpose}_{0 , 2 , 1} ( {Att}^{B \times N \times L} ) ) ; and \\ {Out}^{B \times ( N + 1 ) \times L} = Concatenate ( {Att}^{B \times N \times L} , {f}_{Class}^{1 \times L} ) .\end{matrix}$$

In the above formulas, B represents a batch size; N represents the number of features; L represents a feature length; l represents a classification token feature; MLP represents a multi-layer perceptron; Q, K and V represent intermediate variables involved in conversion of the feature F^{B×N×L}; Att^{B×N×L} represents an intermediate variable of the self-attention mechanism;

$${f}_{Class}^{1 \times L}$$

is a class token, which is generated through a random initialization strategy and used to learn global instance information; and Transpose_{0,2,1}(·) represents an operation that transposes dimensions of a tensor from (0, 1, 2) to (0, 2, 1).

The procedure is defined as follows:

Algorithm flow of global attention submodule

```
  Input feature: F^{B×(N+1)×L}. Output feature: Out^{B×(N+1)×L}.
  # B represents a batch size, N represents the number of features, 1
represents a classification token feature, and L represents a feature
length.
  $1 ) {F}^{B \times ( N + 1 ) \times L} , {f}_{Class}^{1 \times L} = Split ( {F}^{B \times ( N + 1 ) \times L} )$
  2) Q = MLP(F^{B×N×L})
  3) K = MLP(F^{B×N×L})
  4) V = MLP(F^{B×N×L})
  5) Att^{B×N×L} = Softmax(Transpose_{0,2,1}(Q × K))
  6) Att^{B×N×L} = Concat(V × Transpose_{0,2,1}(Att^{B×N×L}))
  $7 ) {Out}^{B \times ( N + 1 ) \times L} = Concatenate ( {Att}^{B \times N \times L} , {f}_{Class}^{1 \times L} )$
```

(S223) Feature expansion and class label embedding

Since the CNN cannot process irregular feature matrices, data augmentation is required to maintain normality of a feature matrix. Accordingly, the GLT module performs random sampling-based population on an input feature bag. After population, populated features are concatenated with a randomly initialized class token to serve as an input of a transformer layer, as illustrated in the data augmentation portion of FIG. 5.

(S3) The MAT classification network model is training in two stages, where a first stage involves training the self-supervised magnification aligned module, and a second stage involves training the global-local Transformer classification module. The training details are as follows.

(S31) Training of the self-supervised magnification aligned module

During training, the dataset is randomly divided into a training set and a validation set. The self-supervised magnification-aligned module employs an L1 loss function to reduce an absolute distance between features of different magnifications, thereby achieving near-lossless semantic alignment. The L1 loss function is expressed as follows:

$${L}_{MA} = {\sum }_{i = 1}^{n} \vert {X}_{i} - {x}_{i} \vert .$$

In the above formula, Xᵢ is an output feature of an i-th patch from the Φ_{High}(·), and xᵢ is an output feature of an i-th patch from the Φ_{Align}(·). No data augmentation strategies are employed during training, as the available samples are sufficient to meet the requirements of the model.

In an embodiment, parameters of the self-supervised magnification aligned module are updated using an Adam optimizer with an initial learning rate of 1×10⁻⁴. The learning rate follows a linear decay schedule with a decay factor of 0.9.

(S32) Training of the global-local Transformer classification module;

The global-local Transformer classification module employs a cross-entropy loss function, expressed as:

$${L}_{GLT} = - {\sum }_{i = i}^{n} {y}_{i} log .$$

In the above formula, y represents an output corresponding to an i-th WSI among the plurality of WSIs, and [symbol] represents a label corresponding to the i-th WSI. The global-local Transformer classification module randomly initializes model parameters. During training, the instances within each input bag are randomly shuffled as a form of data augmentation, whereas during model inference, the instances are arranged in the same order as in the feature extraction stage.

(S4) A pathological image classification prediction result is obtained using the trained MAT classification network model.

Unlike conventional methods that require high-resolution input images (400× (40×) or 200× (20×)), the MAT model only requires low-resolution input images (100× (10×), 50× (5×), or even 25× (2.5×)). Meanwhile, the MAT maintains a prediction performance comparable to that of state-of-the-art models, while improving computational efficiency by a factor of 20 to 40 and reducing the amount of data required to one sixteenth of the original.

In an embodiment, the following technical solution is adopted.

Step (1) A pathological image dataset composed of a plurality of WSIs is acquired. The pathological image dataset is subjected to tissue segmentation to obtain a mask corresponding to a tissue region. The processing method employed is as described above in the tissue segmentation section.

Step (2) Masks with a tissue area lower than a preset threshold are removed. A patching operation is performed on the tissue region based on the rest of the masks. At a high magnification (e.g., 200×), each patch is set to 224×224 pixels. A size of patches is scaled proportionally with the magnification of a corresponding WSI (e.g., at a low magnification of 100×, each patch is set to 112×112 pixels; at 50×, each patch is set to 56×56 pixels).

Step (3) The obtained patches are then screened. Patches with a tissue area lower than a preset threshold is removed. A tissue area for each patch is calculated based on a tissue area within the mask at a location corresponding thereto.

Step (4) A feature alignment module is trained. After the patches are obtained, an alignment model is trained using a training strategy described in the self-supervised magnification aligned module.

Step (5) After the patches are obtained, feature extraction is performed using the trained network. If raw features are to be extracted, they are obtained by inputting the patches into a ResNet50 pre-trained on ImageNet. If low-magnification aligned features are to be used, feature extraction is performed using the feature alignment network. The specific methods are as described in the self-supervised magnification aligned module.

Step (6) The MAT classification network is trained. Training of the GLT model is performed in accordance with the training strategies described above for the GLT model.

Step (7) Model testing is performed. After the test data have been collected, input features are obtained in the order of steps (S3) and (S5) described above, and are then input into the MAT classification network trained in step (S6) for prediction.

It should be noted that, for the sake of clarity, the method embodiments described above are presented as a series of sequential steps. However, those skilled in the art will recognize that the present disclosure is not limited to the specific order of steps as described, and that certain steps may be performed in a different sequence or concurrently without departing from the scope of the disclosure.

Based on the same concept as the rapid analysis method for pathological images based on the MAT described in the above embodiments, the present disclosure further provides a system for implementing the method described above. For ease of illustration, the structural schematic of the system of the present disclosure only shows the components relevant to the embodiment. Those skilled in the art will appreciate that the illustrated structure does not impose a limitation on the apparatus and may include more or fewer components than those shown, combinations of certain components, or alternative arrangements of components.

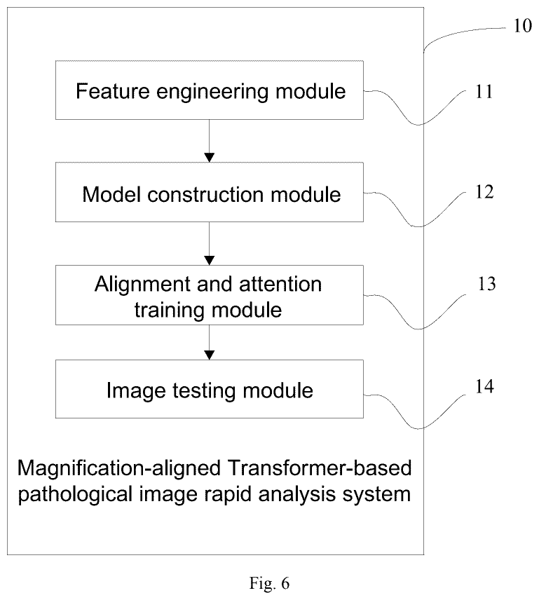

Referring to FIG. 6, an embodiment of the present disclosure provides a system 10 for implementing the method described above. The system 10 includes a feature engineering module 11, a model construction module 12, an alignment and attention training module 13 and an image testing module 14.

The feature engineering module 11 is configured to perform:
acquiring the pathological image dataset composed of the plurality of WSIs;
identifying and segmenting the tissue region within each of the plurality of WSIs to obtain the mask corresponding to the tissue region;
removing masks with the tissue area lower than the preset threshold; and
performing the patching operation on the tissue region based on the rest of the masks.

The model construction module 12 is configured to construct the MAT classification network model. The MAT classification network model includes the self-supervised magnification alignment module and the global-local Transformer classification module. The self-supervised magnification alignment module includes two magnification-dependent feature extractors. The two magnification-dependent feature extractors are structurally identical, and are respectively configured to extract features with fine-grained information and generate semantically aligned features with high similarity. The global-local Transformer classification module includes the global attention submodule and the local attention submodule. The global attention submodule is configured to explore global features among instances based on Transformer's capability to learn global information. The local attention submodule is configured to explore local features among the instances based on CNN's capability to learn detail information.

The alignment and attention training module 13 is configured to perform:
training the MAT classification network model through steps of:
   performing self-supervised magnification alignment training on the MAT classification network model to align low-magnification images to high-magnification images at the feature level to obtain the magnification-aligned feature representation;
   exploring, by the transformer in the global attention submodule, the global information of the magnification-aligned feature representation;
   capturing, by the CNN in the local attention submodule, the local information of the magnification-aligned feature representation;
   aggregating pathological image features based on the global information and the local information to obtain the aggregated features;
   inferring, by the fully connected layer, the prediction result based on the aggregated features;
   computing the prediction loss; and
   obtaining the trained MAT classification network model through the backpropagation algorithm;
   the self-attention mechanism in the transformer of the global attention submodule covers all patches in the magnification-aligned feature representation to obtain global attention; and the CNN in the local attention submodule, based on the fixed-size convolutional kernel and the sliding window mechanism, is more sensitive to adjacent patches in the magnification-aligned feature representation.

The image testing module 14 is configured to test the trained MAT classification network model using the patch set and the magnification-aligned feature representation, so as to obtain the pathological image classification prediction result.

It should be noted that the system provided herein corresponds one-to-one with the method described above. The technical features and their beneficial effects described in the embodiments of the above-mentioned method are equally applicable to the system provided herein. For detailed content, reference may be made to the descriptions of the method embodiments of the present disclosure, which will not be repeated herein.

In addition, in the embodiments of the system described above, the logical division of the program modules is provided for illustrative purposes only. In practical applications, the functions may be allocated to different program modules as needed, for example, to accommodate specific hardware configurations or to facilitate software implementation. That is, the internal structure of the system described above may be divided into different program modules to perform all or part of the functions described above.

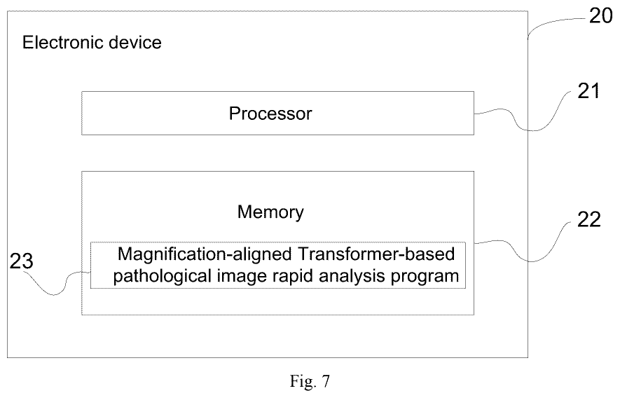

Referring to FIG. 7, an embodiment of the present disclosure provides an electronic device 20 for implementing the method described above. The electronic device 20 includes a processor 21, a memory 22 and a bus. The device further includes a computer program stored in the memory 22 and executable on the processor 21, such as a magnification-aligned Transformer-based rapid pathological image analysis program 23.

The memory 22 includes at least one type of readable storage medium, including flash memory, a mobile hard drive, a multimedia card, card-type memory (e.g., SD or DX memory), magnetic storage, a disk and an optical disk. In some embodiments, the memory 22 may be an internal storage unit of the electronic device 20, such as the mobile hard drive of the electronic device 20. In other embodiments, the memory 22 may be an external storage device of the electronic device 20, such as a plug-in mobile hard drive, a Smart Media Card (SMC), a Secure Digital (SD) card and a flash card, equipped on the electronic device 20. Furthermore, the memory 22 may include both an internal storage unit and external storage devices of the electronic device 20. The memory 22 may be used not only to store application software and various types of data installed on the electronic device 20, such as the code of the magnification-aligned Transformer-based rapid pathological image analysis program 23, but also to temporarily store data that has been output or is to be output.

In some embodiments, the processor 21 may be composed of an integrated circuit, which can be composed of a single packaged integrated circuit or a combination of multiple packaged integrated circuits having the same or different functions, including one or more central processing units (CPU), microprocessors, digital processing chips, graphics processors, and various control chips. The processor 21 serves as the control core (Control Unit) of the electronic device 20, connecting various components of the electronic device through various interfaces and circuits. By executing or running programs or modules stored in the memory 22 and accessing data stored therein, the processor 21 performs various functions of the electronic device 20 and processes data.

Referring to FIG. 7, only an electronic device having components is illustrated. It should be understood by those skilled in the art that the structure shown in FIG. 7 does not limit the electronic device 20 and may include fewer or additional components than illustrated, may combine certain components, or may arrange the components differently.

The magnification-aligned Transformer-based rapid pathological image analysis program 23 stored in the memory 22 of the electronic device 20 includes a plurality of instructions, that, when executed by the processor 21, cause the electronic device 20 to implement the following steps:
acquiring the pathological image dataset composed of the plurality of WSIs;
identifying and segmenting the tissue region within each of the plurality of WSIs to obtain the mask corresponding to the tissue region;
removing masks with the tissue area lower than the preset threshold;
performing the patching operation on the tissue region based on the rest of the masks;
constructing the MAT classification network model;
where the MAT classification network model includes the self-supervised magnification alignment module and the global-local Transformer classification module;
the self-supervised magnification alignment module includes two magnification-dependent feature extractors, where the two magnification-dependent feature extractors are structurally identical, and are respectively configured to extract features with fine-grained information and generate semantically aligned features with high similarity;
the global-local Transformer classification module includes the global attention submodule and the local attention submodule; the global attention submodule is configured to explore global features among instances based on Transformer's capability to learn global information; and the local attention submodule is configured to explore local features among the instances based on CNN's capability to learn detail information;
training the MAT classification network model through steps of:
   performing self-supervised magnification alignment training on the MAT classification network model to align low-magnification images to high-magnification images at the feature level to obtain the magnification-aligned feature representation;
   exploring, by the transformer in the global attention submodule, the global information of the magnification-aligned feature representation;
   capturing, by the CNN in the local attention submodule, the local information of the magnification-aligned feature representation;
   aggregating pathological image features based on the global information and the local information to obtain the aggregated features;
   inferring, by the fully connected layer, the prediction result based on the aggregated features;
   computing the prediction loss; and
   obtaining the trained MAT classification network model through the backpropagation algorithm;
   the self-attention mechanism in the transformer of the global attention submodule covers all patches in the magnification-aligned feature representation to obtain global attention; and the CNN in the local attention submodule, based on the fixed-size convolutional kernel and the sliding window mechanism, is more sensitive to adjacent patches in the magnification-aligned feature representation; and
obtaining the pathological image classification prediction result using the trained MAT classification network model.

Furthermore, if the modules/units integrated within the electronic device 20 are implemented in the form of software functional units and are sold or used as independent products, they can be stored in a non-volatile, computer-readable storage medium. The computer-readable medium may include any entity or device capable of carrying the computer program code, such as a recording medium, a USB flash drive, a portable hard drive, a disk, an optical disc, a computer memory, or a read-only memory (ROM).

A person having ordinary skill in the art would understand that all or part of the processes of the above-described embodiments can be implemented by a computer program instructing the relevant hardware to perform the operations. The program may be stored in a non-volatile computer-readable storage medium and, when executed, may include the steps of the methods described above. Any reference to a memory, storage, database, or other medium used in the embodiments provided in the present disclosure may include non-volatile and/or volatile memory. The non-volatile memory may include read-only memory (ROM), programmable ROM (PROM), electrically programmable ROM (EPROM), electrically erasable programmable ROM (EEPROM), or flash memory. The volatile memory may include random-access memory (RAM) or external cache memory. By way of illustration and not limitation, RAM may be available in various forms, such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The technical features of the above embodiments may be combined in any suitable manner. For the sake of brevity, not all possible combinations of the technical features described in the above embodiments are explicitly set forth. Nevertheless, any combination of these technical features that does not result in a contradiction should be considered within the scope of the disclosure as described herein.

The embodiments described above are merely preferred embodiments of the present disclosure, and are not intended to limit the scope of the present disclosure. Any equivalent structural changes made based on the description and the accompanying drawings of the present disclosure under the inventive concept of the present disclosure, or direct/indirect application in other related technical fields shall fall within the scope of the present disclosure defined by the appended claims.

What is claimed is:

1. A method for analyzing pathological images based on a magnification-aligned Transformer (MAT), comprising:
acquiring a pathological image dataset composed of a plurality of whole-slide images (WSIs); identifying and segmenting a tissue region within each of the plurality of WSIs to obtain a mask corresponding to the tissue region; removing masks with a tissue area lower than a preset threshold; performing a patching operation on the tissue region based on the rest of the masks;
constructing a MAT classification network model;
wherein the MAT classification network model comprises a self-supervised magnification alignment module and a global-local Transformer classification module;
the self-supervised magnification alignment module comprises two magnification-dependent feature extractors, wherein the two magnification-dependent feature extractors are structurally identical, and are respectively configured to extract features with fine-grained information and generate semantically aligned features with high similarity;
the global-local Transformer classification module comprises a global attention submodule and a local attention submodule; the global attention submodule is configured to explore global features among instances based on Transformer's capability to learn global information; and the local attention submodule is configured to explore local features among the instances based on convolutional neural network (CNN)'s capability to learn detail information;
training the MAT classification network model through steps of:
performing self-supervised magnification alignment training on the MAT classification network model to align low-magnification images to high-magnification images at a feature level to obtain a magnification-aligned feature representation;
exploring, by a transformer in the global attention submodule, global information of the magnification-aligned feature representation;
capturing, by a CNN in the local attention submodule, local information of the magnification-aligned feature representation;
aggregating pathological image features based on the global information and the local information to obtain aggregated features;
inferring, by the fully connected layer, the prediction result based on the aggregated features;
computing a prediction loss; and
obtaining a trained MAT classification network model through a backpropagation algorithm;
wherein a self-attention mechanism in the transformer of the global attention submodule covers all patches to obtain global attention; and the CNN in the local attention submodule, based on a fixed-size convolutional kernel and a sliding window mechanism, is more sensitive to adjacent patches; and
obtaining a pathological image classification prediction result using the trained MAT classification network model.

2. The method of claim 1, wherein the step of identifying and segmenting the tissue region within each of the plurality of WSIs to obtain the mask, and performing the patching operation on the tissue region based on the mask comprises:
performing binary classification on the pathological image dataset by using ImageNet to distinguish the tissue region from blank and contaminated regions, so as to obtain the mask corresponding to the tissue region;
performing the patching operation on the tissue region based on the mask, wherein all WSIs are cropped into patches of a predetermined size; and
inputting the patches of the predetermined size into a ResNet50 pre-trained on ImageNet or a pathology foundation model for feature extraction;
wherein a size of the patches is scaled proportionally with a magnification of a corresponding WSI.

3. The method of claim 1, wherein the step of performing self-supervised magnification alignment training on the MAT classification network model comprises:
based on the two magnification-dependent feature extractors Φ_{High}(·) and Φ_{Align}(·), freezing parameters of the Φ_{High}(·) to extract the high-magnification features; wherein the Φ_{High}(·) is configured to receive a high-magnification image as input and output the high-magnification features; and
inputting a low-resolution image having an identical field of view as the high-magnification image into the Φ_{Align}(·) to generate the semantically-aligned features; and
processing the high-magnification features and the semantically-aligned features by using an L1 loss function to reduce an absolute distance between features of different magnifications, so as to achieve semantic alignment, wherein the L1 loss function is expressed as:
$${L}_{MA} = {\sum }_{i = 1}^{n} \vert {X}_{i} - {x}_{i} \vert ;$$
wherein Xᵢ is an output feature of an i-th patch from the Φ_{High}(·), and xᵢ is an output feature of an i-th patch from the Φ_{Align}(·).

4. The method of claim 1, wherein the step of exploring, by the transformer in the global attention submodule, the global information of the magnification-aligned feature representation comprises:
inputting a feature F^{B×(N+1)×L} of the patches into the global attention submodule;
exploring the global information Out^{B×(N+1)×L} of the magnification-aligned feature representation using the transformer in the global attention submodule through steps of:
generating a query (Q) vector, a key (K) vector and a value (V) vector using the fully connected layer;
generating a global attention matrix based on the self-attention mechanism using the Q vector and the K vector;
calculating a dot product of the global attention matrix and the V vector; and
concatenating the dot product with a randomly initialized class token to generate an output Out^{B×(N+1)×L} as the global information, expressed as:
$$\begin{matrix}Q = MLP ( {F}^{B \times N \times L} ) ; \\ K = MLP ( {F}^{B \times N \times L} ) ; \\ V = MLP ( {F}^{B \times N \times L} ) ; \\ {Att}^{B \times N \times L} = Softmax ( {Transpose}_{0 , 2 , 1} ( Q \times K ) ) ; \\ {Att}^{B \times N \times L} = Concat ( V \times {Transpose}_{0 , 2 , 1} ( {Att}^{B \times N \times L} ) ) ; and \\ {Out}^{B \times ( N + 1 ) \times L} = Concatenate ( {Att}^{B \times N \times L} , {f}_{Class}^{1 \times L} ) ;\end{matrix}$$
wherein B represents a batch size; N represents the number of features; L represents a feature length; l represents a classification token feature; MLP represents a multi-layer perceptron; Q, K and V represent intermediate variables involved in conversion of the feature F^{B×N×L}; Att^{B×N×L} represents an intermediate variable of the self-attention mechanism;
$${f}_{Class}^{1 \times L}$$
is a class token, which is generated through a random initialization strategy and used to learn global instance information; and Transpose_{0,2,1}(·) represents an operation that transposes dimensions of a tensor from (0, 1, 2) to (0, 2, 1).

5. The method of claim 1, wherein the step of capturing, by the CNN in the local attention submodule, the local information of the magnification-aligned feature representation comprises:
constructing an instance-level feature pyramid by using dilated convolutions in the CNN respectively with dilation rates of 1, 3 and 5 to capture instance information at three scales, respectively denoted as f₁, f₂ and f₃; and
fusing the instance information at the three scales by averaging to acquire the local information of the magnification-aligned feature representation, expressed as:
$$\begin{matrix}{f}_{1} = {Conv}_{1} ( f ) ; \\ {f}_{2} = {Conv}_{3} ( f ) ; \\ {f}_{3} = {Conv}_{5} ( f ) ; and \\ {f}_{out} = Mean ( {f}_{1} , {f}_{2} , {f}_{3} ) ;\end{matrix}$$
wherein f represents an input feature, Convᵢ(·) represents a dilated convolution with a dilation rate of i, Mean(·) represents an averaging pooling operation, and fₒᵤₜ represents an output feature.

6. The method of claim 1, wherein the steps of inferring, by the fully connected layer, the prediction result based on the aggregated features, and computing the prediction loss comprise:
during a training process, computing a loss of the aggregated features through the fully connected layer using a cross-entropy loss function to generate augmented data, expressed as:
$${L}_{GLT} = - {\sum }_{i = i}^{n} {y}_{i} log ;$$
wherein [symbol] represents an output corresponding to an i-th WSI among the plurality of WSIs, and yᵢ represents a label corresponding to the i-th WSI;
arranging the augmented data in the same order as that before aggregation of the pathological image features; and
inferring the prediction result using the fully connected layer of the MAT classification network model.

7. The method of claim 1, wherein the step of training the MAT classification network model further comprises:
before training, subjecting the magnification-aligned feature representation to data augmentation and class label embedding through steps of:
performing random sampling-based population on features of the magnification-aligned feature representation; and
concatenating populated features with a randomly initialized class token to serve as an input of a transformer layer.

8. The method of claim 1, wherein the pathological image features are aggregated based on the global information and the local information using an averaging operation.

9. A system for implementing the method of claim 1, comprising:
a feature engineering module;
a model construction module;
an alignment and attention training module; and
an image testing module;
wherein the feature engineering module is configured to perform:
acquiring the pathological image dataset composed of the plurality of WSIs;
identifying and segmenting the tissue region within each of the plurality of WSIs to obtain the mask corresponding to the tissue region;
removing masks with the tissue area lower than the preset threshold;
performing the patching operation on the tissue region based on the rest of the masks;
the model construction module is configured to construct the MAT classification network model;
wherein the MAT classification network model comprises the self-supervised magnification alignment module and the global-local Transformer classification module;
the self-supervised magnification alignment module comprises two magnification-dependent feature extractors, wherein the two magnification-dependent feature extractors are structurally identical, and are respectively configured to extract features with fine-grained information and generate semantically aligned features with high similarity;
the global-local Transformer classification module comprises the global attention submodule and the local attention submodule; the global attention submodule is configured to explore global features among instances based on Transformer's capability to learn global information; and the local attention submodule is configured to explore local features among the instances based on CNN's capability to learn detail information; and
the alignment and attention training module is configured to perform:
training the MAT classification network model through steps of:
performing self-supervised magnification alignment training on the MAT classification network model to align low-magnification images to high-magnification images at the feature level to obtain the magnification-aligned feature representation;
exploring, by the transformer in the global attention submodule, the global information of the magnification-aligned feature representation;
capturing, by the CNN in the local attention submodule, the local information of the magnification-aligned feature representation;
aggregating pathological image features based on the global information and the local information to obtain the aggregated features;
inferring, by the fully connected layer, the prediction based on the aggregated features;
computing the prediction loss; and
obtaining the trained MAT classification network model through the backpropagation algorithm;
wherein the self-attention mechanism in the transformer of the global attention submodule covers all patches in the magnification-aligned feature representation to obtain global attention; and the CNN in the local attention submodule, based on the fixed-size convolutional kernel and the sliding window mechanism, is more sensitive to adjacent patches in the magnification-aligned feature representation; and
the image testing module is configured to obtain the pathological image classification prediction result using the trained MAT classification network model.

10. An electronic device, comprising:
at least one processor; and
a memory communicatively coupled to the at least one processor;
wherein the memory is configured for storing computer program instructions executable by the at least one processor; and the at least one processor is configured for executing the computer program instructions to implement the method of claim 1.
